(19) United States
(12) Patent Application Publication
(10) Pub. No.: US 2023/0268572 A1
(43) Pub. Date: Aug. 24, 2023

(54) ELECTRICITY STORAGE DEVICE

(71) Applicant: KABUSHIKI KAISHA TOYOTA JIDOSHOKKI, Kariya-shi, Aichi (JP)

(72) Inventors: Hirokuni AKIYAMA, Kariya-shi, Aichi (JP); Ryusuke HASE, Kariya-shi, Aichi (JP); Satoshi YAMAMOTO, Kariya-shi, Aichi (JP); Tomoyuki ITO, Kariya-shi, Aichi (JP); Yuki OKAMOTO, Kariya-shi, Aichi (JP)

(73) Assignee: KABUSHIKI KAISHA TOYOTA JIDOSHOKKI,, Kariya-shi, Aichi (JP)

(21) Appl. No.: 18/024,114

(22) PCT Filed: Aug. 30, 2021
(86) PCT No.: PCT/JP2021/031766

§ 371 Date: Mar. 1, 2023

(30) Foreign Application Priority Data
Sep. 3, 2020 (JP) 2020-148212

(51) Int. Cl. H01M 10/48; H01M 50/204; H01M 50/289; H01M 50/46; H01M 50/569

(52) U.S. Cl. CPC H01M 10/486; H01M 50/204; H01M 50/289; H01M 50/46; H01M 50/569

(57) ABSTRACT

A power storage device includes power storage cells that are stacked in a stacking direction, and a temperature sensor configured to measure a temperature of at least one power storage cell to be measured among the power storage cells. Each of the power storage cells includes a positive electrode that includes a first current collector, and a positive electrode active material layer, a negative electrode that includes a second current collector, and a negative electrode active material layer, a separator that is arranged between the positive electrode and the negative electrode, and a sealing portion—that surrounds and seals the positive electrode active material layer and the negative electrode active material layer. The temperature sensor is arranged inside from the sealing portion of the power storage cell to be measured

### TECHNICAL FIELD

The present disclosure relates to an electricity storage device.

### BACKGROUND ART

A battery is a device that generates heat due to use. From the viewpoint of the performance and the degradation of the battery, the internal temperature of the battery is adjusted to an appropriate range. In Patent Literature 1 described below, a bipolar secondary battery is disclosed in which a plurality of bipolar electrodes each including a positive electrode layer formed on one surface of a current collector, and a negative electrode layer formed on the other surface are arranged in series by interposing an electrolyte layer therebetween. In the bipolar secondary battery, an extension portion extending outward from the positive electrode layer and the negative electrode layer is provided in a part of each of the current collectors, a sealing material for insulation between the current collectors is provided in the extension portion, a non-sealing portion in which the sealing material does not exist is formed on the extension portion of the current collector in an outer circumferential portion of the sealing material, and a detection element for detecting a temperature is arranged in contact with the non-sealing portion.

### CITATION LIST

### Patent Literature

Patent Literature 1: Japanese Unexamined Patent Publication No. 2008-117626

### SUMMARY OF INVENTION

### Technical Problem

In the battery as disclosed in Patent Literature 1 described above, the detection element detecting the temperature of the power storage cell is arranged in a portion outside from the sealing material surrounding the positive electrode layer or the negative electrode layer in the current collector. Accordingly, it is not possible to precisely measure the internal temperature of the power storage cell. In particular, in a case where a coating area of an active material layer in the positive electrode layer and the negative electrode layer of the power storage cell increases, a temperature difference between an end portion and a center portion of the power storage cell tends to increase. In other words, in a case where the coating area increases, a difference between the outer temperature and the internal temperature of the power storage cell tends to increase. Here, in Patent Literature 1 described above, since the detection element is provided outside the sealing material, the detection element measures the outer temperature of the battery. Accordingly, in the case of using the detection element represented in Patent Literature 1 described above, for example, it is difficult to precisely measure the internal temperature of the power storage cell (in particular, the power storage cell positioned on the center of the battery) when used.

An object of the present disclosure is to provide a power storage device that is capable of precisely measuring the internal temperature of a power storage cell when used.

### Solution to Problem

A power storage device according to one aspect of the present disclosure includes power storage cells that are stacked in a stacking direction, and a temperature sensor that measures a temperature of at least one power storage cell to be measured among the power storage cells. Each of the power storage cells includes a positive electrode that includes a first current collector, and a positive electrode active material layer provided on one surface of the first current collector, a negative electrode that includes a second current collector, and a negative electrode active material layer provided on one surface of the second current collector, and is arranged such that the negative electrode active material layer faces the positive electrode active material layer in the stacking direction, a separator that is arranged between the positive electrode and the negative electrode, and a sealing portion that is provided between the first current collector and the second current collector facing each other in the stacking direction, and surrounds the positive electrode active material layer and the negative electrode active material layer to be sealed, and the temperature sensor is arranged inside from the sealing portion of the power storage cell to be measured when seen from the stacking direction.

The power storage device described above includes the temperature sensor measuring the temperature of at least one power storage cell to be measured among the power storage cells, and the temperature sensor is arranged inside from the sealing portion of the power storage cell to be measured when seen from the stacking direction. Accordingly, for example, even in a case where the power storage cell to be measured is positioned on the center side of the power storage device in the stacking direction, it is possible to precisely measure the internal temperature when used by the temperature sensor.

The temperature sensor may be in contact with the first current collector or the second current collector. In this case, it is possible to precisely measure the internal temperature of the power storage cell by the temperature sensor via the first current collector or the second current collector.

The power storage device described above may further include a stacked body that includes the power storage cells, and a sealing body that is provided by integrating the sealing portions included in the power storage cells, respectively, extends from one end to the other end of the stacked body in the stacking direction, and seals the stacked body, and the temperature sensor may be arranged between one end and the other end of the stacked body in the stacking direction. In this case, it is possible to precisely measure the internal temperature of the stacked body by the temperature sensor.

The power storage cells may include a first power storage cell and a second power storage cell adjacent to each other in the stacking direction, the first current collector of the first power storage cell and the second current collector of the second power storage cell may be adjacent to each other in the stacking direction, and the temperature sensor may be arranged between the first current collector of the first power storage cell and the second current collector of the second power storage cell. In this case, it is possible for the temperature sensor to precisely measure the internal temperature of the first power storage cell and the second power storage cell, without decreasing power storage performance of the first power storage cell and the second power storage cell.

The power storage device described above may further include a first stacked body that includes two or more power storage cells included in the power storage cells, a second stacked body that is adjacent to the first stacked body in the stacking direction, and includes two or more other power storage cells included in the power storage cells, a first sealing body that is provided by integrating the sealing portions of the power storage cells included in the first stacked body, extends from one end to the other end of the first stacked body in the stacking direction, and seals the first stacked body, and a second sealing body that is provided by integrating the sealing portions of the power storage cells included in the second stacked body, extends from one end to the other end of the second stacked body in the stacking direction, and seals the second stacked body, the first current collector of a first power storage cell that is one power storage cell included in the first stacked body and the second current collector of a second power storage cell that is one power storage cell included in the second stacked body may be adjacent to each other in the stacking direction, and the temperature sensor may be arranged between the first current collector that is a positive terminal electrode arranged on one end of the first stacked body and the second current collector that is a negative terminal electrode arranged on one end of the second stacked body. In this case, it is possible to precisely measure the internal temperature of the first stacked body via the first current collector of the first power storage cell and/or the internal temperature of the second stacked body via the second current collector of the second power storage cell by the temperature sensor. In addition, by the first sealing body and the second sealing body, it is possible to arrange the temperature sensor without impairing sealing properties of each of the first stacked body and the second stacked body.

The power storage device described above may further include a first cooler that is in contact with the positive terminal electrode of the first stacked body, and a second cooler that is in contact with the negative terminal electrode of the second stacked body. In this case, it is possible to precisely measure the internal temperature of the first stacked body and/or the second stacked body by the temperature sensor while adequately maintaining the temperature of the power storage device.

A recess in which the temperature sensor is contained may be provided in at least one of the first current collector of the first power storage cell and the second current collector of the second power storage cell. In this case, it is possible to suppress a damage to the first current collector and/or the second current collector due to the temperature sensor.

The power storage cells may include a first power storage cell in which the temperature sensor is arranged, and the temperature sensor may be arranged in a space sealed by the sealing portion of the first power storage cell, the first current collector of the first power storage cell, and the second current collector of the first power storage cell. In this case, it is possible for the temperature sensor to precisely measure the internal temperature of the first power storage cell.

The temperature sensor may be contained in a groove that is provided in the positive electrode active material layer or a groove that is provided in the negative electrode active material layer. In this case, it is possible to suppress a damage to the first power storage cell due to the temperature sensor.

The temperature sensor may be embedded in the positive electrode active material layer or the negative electrode active material layer. In this case, since the movement of the temperature sensor due to an impact or the like on the power storage device is suppressed, the first current collector and the temperature sensor, or the second current collector and the temperature sensor are less likely to cause friction. Accordingly, it is possible to suppress a damage to the first power storage cell due to the temperature sensor.

The temperature sensor may be arranged in a center region of the power storage cell to be measured when seen from the stacking direction. In this case, it is possible to more precisely measure the internal temperature of the power storage cell to be measured by the temperature sensor.

A plurality of temperature sensors including the temerature sensor may be provided in a certain power storage cell among the power storage cells, and the temperature sensors arranged to be separated from each other when seen from the stacking direction may measure a temperature distribution of the certain power storage cell. In this case, it is possible to precisely measure an internal temperature distribution of the predetermined power storage cell along a surface direction orthogonal to the stacking direction by the temperature sensors.

The power storage device described above may further include a flexible printed circuit that is electrically connected to the temperature sensor, the temperature sensor may be provided on one end of the flexible printed circuit, and the other end of the flexible printed circuit may be connected to a control circuit arranged outside the power storage cells. In this case, it is possible to successfully transmit a measurement result of the temperature sensor to the control circuit positioned outside the stacked body.

The flexible printed circuit may include a voltage detection unit that is in contact with a current collector included in any one of the power storage cells. In this case, it is possible to measure the voltage of any portion in the power storage device by a temperature sensing unit.

The flexible printed circuit may include a conductive portion that is connected to the temperature sensor, and an insulating portion that covers the conductive portion, and the temperature sensor may be covered with the insulating portion. In this case, it is possible to suppress the malfunction of the temperature sensor.

### Advantageous Effects of Invention

According to the present disclosure, it is possible to provide the power storage device that is capable of precisely measuring the internal temperature of the power storage cell when used.

### BRIEF DESCRIPTION OF DRAWINGS

FIG. 1 is a schematic sectional view illustrating a power storage device of a first embodiment.

(a) of FIG. 2 is a plan view illustrating a part of a cell stack, and (b) of FIG. 2 is a schematic sectional view illustrating an example of a lead wire.

(a) to (d) of FIG. 3 are sectional views illustrating each step of a method for manufacturing the power storage device of the first embodiment.

FIG. 4 is a sectional view illustrating one step of the method for manufacturing the power storage device of the first embodiment.

FIG. 5 is a schematic sectional view illustrating a power storage device according to a first modification example.

FIG. 6 is a plan view illustrating a part of a cell stack according to the first modification example.

FIG. 7 is a schematic sectional view illustrating a power storage device according to a second modification example.

FIG. 8 is a schematic sectional view illustrating a power storage device according to a third modification example.

FIG. 9 is a schematic sectional view illustrating a power storage device according to a fourth modification example.

FIG. 10 is a schematic sectional view illustrating a power storage device according to a second embodiment.

FIG. 11 is a schematic sectional view illustrating a power storage device according to a third embodiment.

FIG. 12 is a schematic sectional view illustrating a cell stack according to the third embodiment.

FIG. 13 is a schematic sectional view illustrating a power storage device according to a modification example of the third embodiment.

(a) of FIG. 14 is a schematic plan view illustrating main parts of an example of a temperature sensing unit, and (b) of FIG. 14 is a schematic plan view illustrating main parts of another example of the temperature sensing unit.

### DESCRIPTION OF EMBODIMENTS

Hereinafter, embodiments of the present disclosure will be described in detail, with reference to the attached drawings. In the description of the drawings, the same reference numerals will be used in the same or equivalent elements, and the repeated description will be omitted.

### First Embodiment

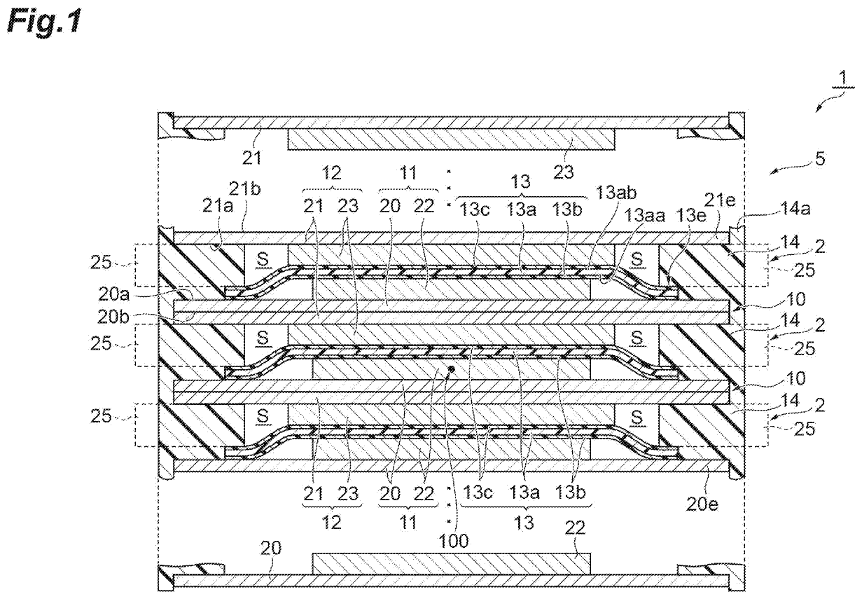

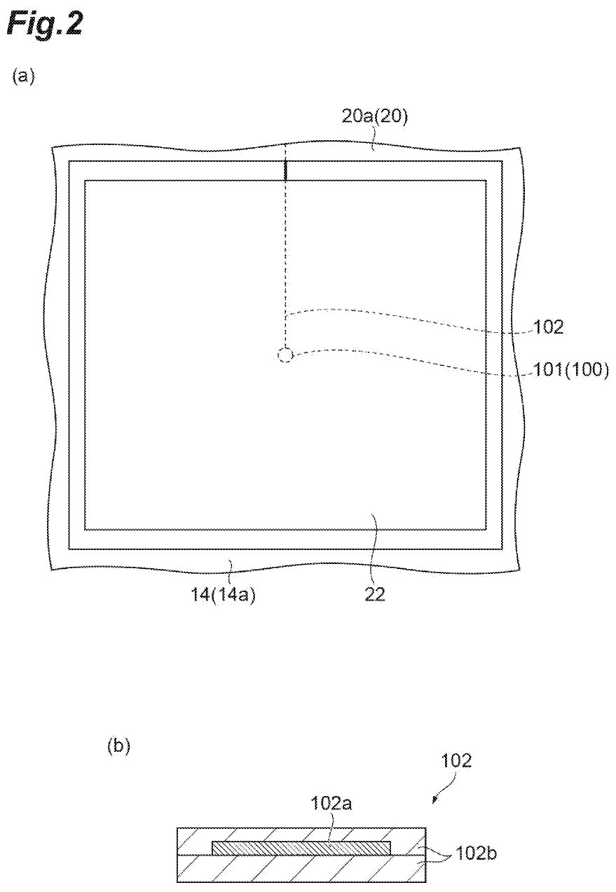

FIG. 1 is a schematic sectional view illustrating a power storage device of a first embodiment. A power storage device 1 illustrated in FIG. 1, for example, is a power storage module that is used in batteries of various vehicles such as a forklift, a hybrid car, and an electrical car. The power storage device 1, for example, is a secondary battery such as a nickel-hydrogen secondary battery or a lithium ion secondary battery. The power storage device 1 may be an electrical double layer capacitor, or may be an all-solid-state battery. In the first embodiment, a case will be exemplified in which the power storage device 1 is a lithium ion secondary battery.

The power storage device 1 includes a cell stack 5 (a stacked body) in which a power storage cells 2 are stacked in a stacking direction, and a temperature sensing unit 100. As illustrated in FIG. 1, each of the power storage cells 2 includes a positive electrode 11, a negative electrode 12, a separator 13, and a sealing portion 14. The positive electrode 11 includes a first current collector 20, and a positive electrode active material layer 22 provided on one surface 20a of the first current collector 20. The positive electrode 11, for example, is a rectangular electrode when seen from the stacking direction. The negative electrode 12 includes a second current collector 21, and a negative electrode active material layer 23 provided on one surface 21a of the second current collector 21. The negative electrode 12, for example, is a rectangular electrode when seen from the stacking direction. The negative electrode 12 is arranged such that the negative electrode active material layer 23 faces the positive electrode active material layer 22 in the stacking direction. In the first embodiment, both of the positive electrode active material layer 22 and the negative electrode active material layer 23 are formed into the shape of a rectangle when seen from the stacking direction. The negative electrode active material layer 23 is formed to be slightly larger than the positive electrode active material layer 22. The entire formation region of the positive electrode active material layer 22 is positioned in the formation region of the negative electrode active material layer 23 when seen from the stacking direction.

The first current collector 20 includes the other surface 20b that is a surface on a side opposite to one surface 20a. The positive electrode active material layer 22 is not formed on the other surface 20b. The second current collector 21 includes the other surface 21b that is a surface on a side opposite to one surface 21a. The negative electrode active material layer 23 is not formed on the other surface 21b. By stacking the power storage cells 2 such that the other surface 20b of the first current collector 20 and the other surface 21b of the second current collector 21 are in contact with each other, the cell stack 5 is configured. Accordingly, the power storage cells 2 are electrically connected to each other in series. In the cell stack 5, in the power storage cells 2 and 2 adjacent to each other along the stacking direction, the first current collector 20 of one power storage cell 2 and the second current collector 21 of the other power storage cell 2 are in contact with each other. In the cell stack 5, a pseudo-bipolar electrode 10 including the first current collector 20 and the second current collector 21 as an electrode body is formed. That is, one bipolar electrode 10 includes the first current collector 20, the second current collector 21, the positive electrode active material layer 22, and the negative electrode active material layer 23. The first current collector 20 is arranged as a terminal electrode on one end of the cell stack 5 in the stacking direction. The second current collector 21 is arranged as a terminal electrode on the other end of the cell stack 5 in the stacking direction.

Each of the first current collector 20 and the second current collector 21 (hereinafter, may be simply referred to as a “current collector”) is a chemically inert electrical conductor for keeping a current flowing to the positive electrode active material layer 22 and the negative electrode active material layer 23 during the discharge or the charge of the lithium ion secondary battery. Examples of the material configuring the current collector include a metal material, a conductive resin material, a conductive inorganic material, and the like. Examples of the conductive resin material include a resin obtained by adding, as necessary, a conductive filler to a conductive polymer material or a non-conductive polymer material, and the like. The current collector may include a plurality of layers including one or more layers containing the metal material or the conductive resin material described above. A covering layer may be formed on the surface of the current collector by a known method such as a plating treatment or spray coating. The current collector, for example, may be formed into the shape of a plate, a foil, a sheet, a film, a mesh, and the like. In a case where the current collector is a metal foil, for example, an aluminum foil, a copper foil, a nickel foil, a titanium foil, a stainless steel foil, or the like is used. The current collector may be an alloy foil or a clad foil of the metals described above. In the case of a foil-shaped current collector, the thickness of the current collector may be in a range of 1 μm to 100 μm. In the first embodiment, the first current collector 20 is an aluminum foil, and the second current collector 21 is a copper foil.

The positive electrode active material layer 22 contains a positive electrode active material that is capable of occluding and releasing a charge carrier such as a lithium ion. As the positive electrode active material, materials that can be used as a positive electrode active material of a lithium ion secondary battery, such as a lithium composite metal oxide having a layer-shaped rock-salt structure, a metal oxide having a spinel structure, and a polyanionic compound, may be adopted. In addition, two or more types of positive electrode active materials may be used together. In the first embodiment, the positive electrode active material layer 22 contains olivine lithium iron phosphate (LiFePO₄) as a composite oxide.

As the material of the negative electrode active material layer 23, any material can be used without being particularly limited, insofar as the material is an elemental metal, an alloy, or a compound that is capable of occluding and releasing a charge carrier such as a lithium ion. Examples of the negative electrode active material include Li, carbon, a metal compound, an element that can be alloyed with lithium or a compound thereof, and the like. Examples of the carbon may include natural graphite, synthetic graphite, hard carbon (difficult graphitization carbon), or soft carbon (easy graphitization carbon). Examples of the synthetic graphite include high orientation graphite and mesocarbon microbead. Examples of the element that can be alloyed with lithium include silicon and tin. In this embodiment, the negative electrode active material layer 23 contains graphite as a carbon-based material.

Each of the positive electrode active material layer 22 and the negative electrode active material layer 23 (hereinafter, may be simply referred to as an “active material layer”), as necessary, may further contain a conductive aid, a binder, an electrolyte (a polymer matrix, an ion conductive polymer, an electrolytic solution, or the like), an electrolyte support salt (a lithium salt) for improving ion conductivity, and the like. Components contained in the active material layer, a compound ratio of the components, and the thickness of the active material layer are not particularly limited, and it is possible to suitably refer to known findings on a lithium ion secondary battery of the related art. The thickness of the active material layer, for example, is 2 to 150 μm. The active material layer may be formed on the surface of the current collector by using a known method of the related art, such as a roll coating method. In order to improve heat stability of the positive electrode 11 or the negative electrode 12, a heat resistant layer may be provided on the surface (one surface or both surfaces) of the current collector or the surface of the active material layer. The heat resistant layer, for example, may contain inorganic particles and a binder, and may further contain an additive such as a thickener.

The conductive aid is added to improve the conductivity of the positive electrode 11 or the negative electrode 12. The conductive aid, for example, is acetylene black, carbon black, graphite, or the like. The binder has a function of binding the active material or the conductive aid to the surface of the current collector.

The separator 13 is a member that is arranged between the positive electrode 11 and the negative electrode 12, and allows the charge carrier such as a lithium ion to pass through. The separator 13 is also a member that separates the positive electrode 11 and the negative electrode 12 from each other to prevent a short circuit due to contact between both electrodes. The separator 13, for example, is a porous sheet or an unwoven fabric containing a polymer that absorbs and retains an electrolyte. Examples of the material configuring the separator 13 include polypropylene, polyethylene, polyolefin, polyester, and the like. The separator 13 may have a single-layer structure or a multiple-layer structure. The multiple-layer structure, for example, may include an adhesive layer, a ceramic layer as the heat resistant layer, and the like. The separator 13 may be impregnated with the electrolyte, or the separator 13 itself may contain the electrolyte such as a polymer electrolyte or an inorganic electrolyte. In this embodiment, the separator 13 includes a base material layer 13a, a first adhesive layer 13b provided on a first surface 13aa of the base material layer 13a, and a second adhesive layer 13c provided on a second surface 13ab of the base material layer 13a.

Examples of the electrolyte impregnated in the separator 13 include a liquid electrolyte (an electrolytic solution) containing a non-aqueous solvent and an electrolytic salt dissolved in the non-aqueous solvent, a polymer gel electrolyte containing an electrolyte retained in a polymer matrix, and the like. The electrolytic solution is contained in a space S of the power storage device 1.

In a case where the separator 13 is impregnated with the electrolytic solution, as the electrolytic salt, a known lithium salt such as LiClO₄, LiAsF₆, LiPF₆, LiBF₄, LiCF₃SO₃, LiN(FSO₂)₂, and LiN(CF₃SO₂)₂ can be used. In addition, as the non-aqueous solvent, a known solvent such as cyclic carbonates, cyclic esters, chain carbonates, chain esters, and ethers can be used. Note that, two or more types of such known solvent materials may be used in combination.

The first adhesive layer 13b adheres to the positive electrode active material layer 22. The second adhesive layer 13c adheres to the negative electrode active material layer 23. The first adhesive layer 13b may be provided on the entire first surface 13aa of the base material layer 13a. The second adhesive layer 13c may be provided on the entire second surface 13ab of the base material layer 13a. Each of the first adhesive layer 13b and the second adhesive layer 13c, for example, may contain a thermosetting resin such as an epoxy resin, a polyimide resin, and a phenolic resin, and may contain an adhesive that is solidified by a reaction with the moisture such as the electrolytic solution.

The sealing portion 14 is a resin member sealing the space S between the positive electrode 11 and the negative electrode 12, and has electrical insulating properties. The sealing portion 14 seals the space S to surround the positive electrode active material layer 22 and the negative electrode active material layer 23. The sealing portion 14 includes a resin frame 25 in the shape of a rectangular frame when seen from the stacking direction, and is welded to an edge portion 20e of the first current collector 20 and an edge portion 21e of the second current collector 21. The sealing portion 14 is formed into the shape of a frame to surround the positive electrode active material and the negative electrode active material contained in the cell stack 5 when seen from the stacking direction. In the first embodiment, a plurality of sealing portions 14 arranged in the stacking direction of the cell stack 5 are integrated to form a sealing body 14a extending from one end to the other end of the cell stack 5 in the stacking direction. For example, the sealing portion 14 includes a junction joined to the current collector, and a protrusion protruding outside from the edge portion of the current collector. For example, by welding the protrusions of the adjacent sealing portions 14, the plurality of sealing portions 14 are integrated. The sealing body 14a is a member that surrounds and integrates the power storage cells 2 to seal the cell stack 5 when seen from the stacking direction, and includes a lateral wall portion. The lateral wall portion extends in the stacking direction from the first current collector arranged on one end of the cell stack 5 in the stacking direction to the second current collector 21 arranged on the other end in the stacking direction. By the lateral wall portion of the sealing body 14a, the lateral surface of the cell stack 5 along the stacking direction is sealed, and the power storage cells 2 adjacent to each other in the stacking direction are sealed. Examples of the resin material configuring the sealing portion 14 include polyethylene (PE), polystyrene, an ABS resin, modified polypropylene (modified PP), and an acrylonitrile styrene (AS) resin.

In the first embodiment, an edge portion 13e of the separator 13 adheres to one surface 20a of the first current collector 20 via the first adhesive layer 13b. One surface 20a of the first current collector 20 includes a coating region that is coated with the positive electrode active material layer 22, and a non-coating region that is not coated with the positive electrode active material layer 22. The non-coating region is provided around the coating region. The separator 13 adheres to the non-coating region. The sealing portion 14 adheres to the second adhesive layer 13c in the edge portion 13e of the separator 13. The edge portion 13e of the separator 13 is fixed by being interposed between one surface 20a of the first current collector 20 and the sealing portion 14.

(a) of FIG. 2 is a plan view illustrating a part of the cell stack. The temperature sensing unit 100 illustrated in FIG. 1 and (a) of FIG. 2 is a device for sensing the temperature of the power storage cell 2 in the cell stack 5. The temperature sensing unit 100 is arranged in contact with the power storage cell 2 to be measured among the plurality of stacked power storage cells 2. In the first embodiment, the temperature sensing unit 100 is included in at least one power storage cell 2 (a first power storage cell) among the power storage cells 2 included in the cell stack 5. Such a temperature sensing unit 100 is arranged in the space S sealed by the sealing portion 14, the first current collector 20 of the positive electrode 11, and the second current collector 21 of the negative electrode 12. In addition, from the viewpoint of suppressing a decrease in the capacity of the negative electrode 12, the temperature sensing unit 100 is embedded not in the negative electrode active material layer 23 of the negative electrode 12, but in the positive electrode active material layer 22 of the positive electrode 11.

The temperature sensing unit 100 includes a temperature sensor 101. The temperature sensor 101 is an element sensing the temperature in the power storage cell 2, and is embedded in the positive electrode active material layer 22. In the first embodiment, the temperature sensor 101 senses the temperature in the positive electrode active material layer 22. The temperature sensor 101 is arranged inside from the sealing portion 14 of the power storage cell 2 when seen from the stacking direction. In the first embodiment, the temperature sensor 101 is arranged in the center region of the cell stack 5 when seen from the stacking direction, between one end and the other end of the cell stack 5 in the stacking direction. The center region, for example, is any one of the center of the positive electrode active material layer 22 and/or the negative electrode active material layer 23 or the vicinity thereof, a region overlapping with the positive electrode active material layer 22 and/or the negative electrode active material layer 23 when seen from the stacking direction, and a part of a region surrounded by the resin frame 25 when seen from the stacking direction. The part, for example, may correspond to a diagram in which the center is the same as that of the resin frame 25, and the length of the diagonal line of the part (or the length of the diameter of the part) is half the length of the diagonal line of the inner frame of the resin frame 25 (or the length of the diameter) when seen from the stacking direction. In the first embodiment, the temperature sensor 101 is arranged on the center of the positive electrode active material layer 22 or in the vicinity thereof The temperature sensor 101, for example, is a thermocouple, a thermistor, or the like. In a case where the temperature sensor 101 is a thermocouple, the temperature sensor 101 corresponds to a portion in which two types of metal wires are in contact with each other. The thermocouple is a known thermocouple, and examples thereof include a chromel-alumel thermocouple, a chromel-constantan thermocouple, a copper-constantan thermocouple, and the like. The thermistor, for example, is an NTC thermistor, a PTC thermistor, or the like. As the thermistor, a thin film-shaped thermistor having flexibility can also be used. The thickness of such a film-shaped thermistor having flexibility (hereinafter, also referred to as a “flexible thermistor”), for example, is 0.1 μm or more and 1 μm or less. By using such a flexible thermistor, it is possible to set the maximum thickness of the temperature sensing unit 100, for example, to 100 μm or less. Accordingly, it is possible to successfully suppress a decrease in the capacity of the power storage cell 2 due to the temperature sensing unit 100. From the viewpoint of preventing a reaction with the electrolytic solution or the like contained in the space S, the temperature sensor 101, for example, is covered with an insulating resin such as polyimide.

A lead wire 102 for transmitting a sensing result of the temperature sensor 101 to a control device (a control circuit) provided outside the power storage device 1 (the cell stack 5) is connected to the temperature sensor 101. The temperature sensor 101 is provided on one end of the lead wire 102. The other end of the lead wire 102 is drawn outside the power storage device 1, and is connected to the control device (not illustrated) monitoring the temperature of the power storage device 1. In a case where the temperature sensor 101 is a thermocouple, the lead wire 102 includes two types of metal wires for configuring the thermocouple. The lead wire 102 extends from the inside of the power storage device 1 in which the temperature sensor 101 is arranged to the outside of the power storage device 1 that is outside from the sealing portion 14 when seen from the stacking direction. Inside the power storage device 1, one part of the lead wire 102 is arranged to be embedded in the positive electrode active material layer 22, and the other part of the lead wire 102 is arranged to be embedded in the sealing portion 14. From the viewpoint of preventing a reaction with the electrolytic solution or the like contained in the space S, the lead wire 102, for example, is covered with a sheath containing an insulating resin. When seen from the stacking direction, one part of the lead wire 102 is positioned inside a region surrounded by the sealing portion 14, and the other part of the lead wire 102 is positioned outside the region.

(b) of FIG. 2 is a schematic sectional view illustrating an example of the lead wire in this embodiment. As illustrated in (b) of FIG. 2, in a case where a sensor such as a thermistor is used as the temperature sensor 101, as the lead wire 102, for example, a flexible thin substrate, that is, a flexible printed circuit (FPC) is used. The lead wire 102 including the FPC is provided with a conductive foil 102a (a conductive portion), and a thin base film 102b (an insulating portion) containing polyimide or the like. The lead wire 102, for example, is formed into the shape of a long sheet in plan view. The conductive foil 102a is connected to the temperature sensor 101, and is attached to the base film 102b. From the viewpoint of preventing a reaction with the electrolytic solution or the like contained in the space S, the conductive foil 102a is covered with the base film 102b. From the viewpoint of suppressing a decrease in the capacity of the power storage cell 2 due to the lead wire 102 and a sealing failure of the sealing portion 14, the thickness of the lead wire 102, for example, is set to 10 μm or more and less than 100 μm.

The thermistor and the conductive foil 102a, and the conductive foil 102a and an external device, for example, are electrically connected to each other through an opening formed in the base film 102b, respectively. The thermistor, for example, may be fixed to the conductive foil 102a via solder, may be fixed to the conductive foil 102a via a conductive adhesive or the like, or may be welded to the conductive foil 102a. In a case where the temperature sensor 101 is a flexible thermistor, the flexible thermistor may be covered with the base film 102b together with the conductive foil 102a. In this case, the flexible thermistor may not be covered with a material other than the base film 102b.

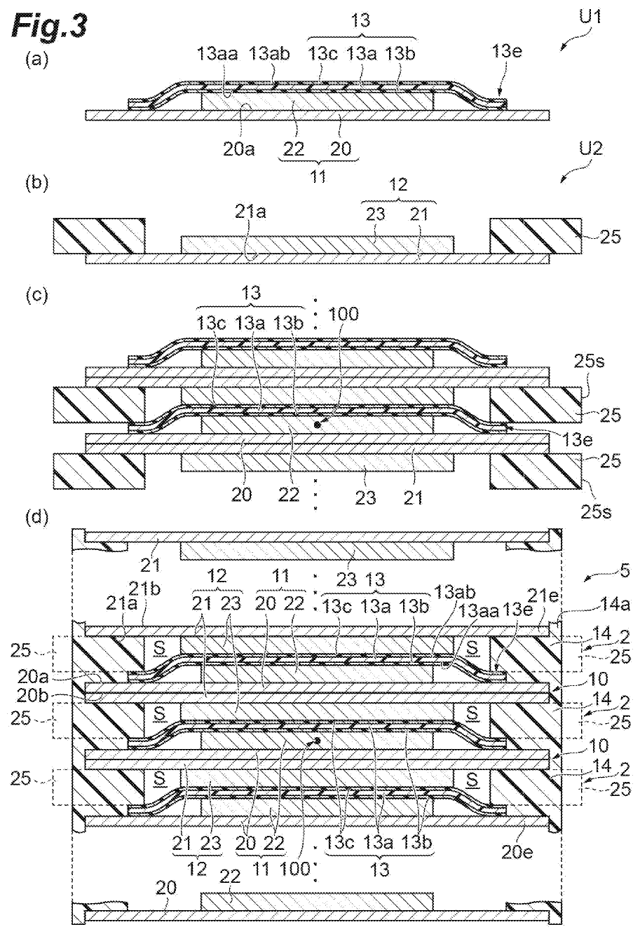

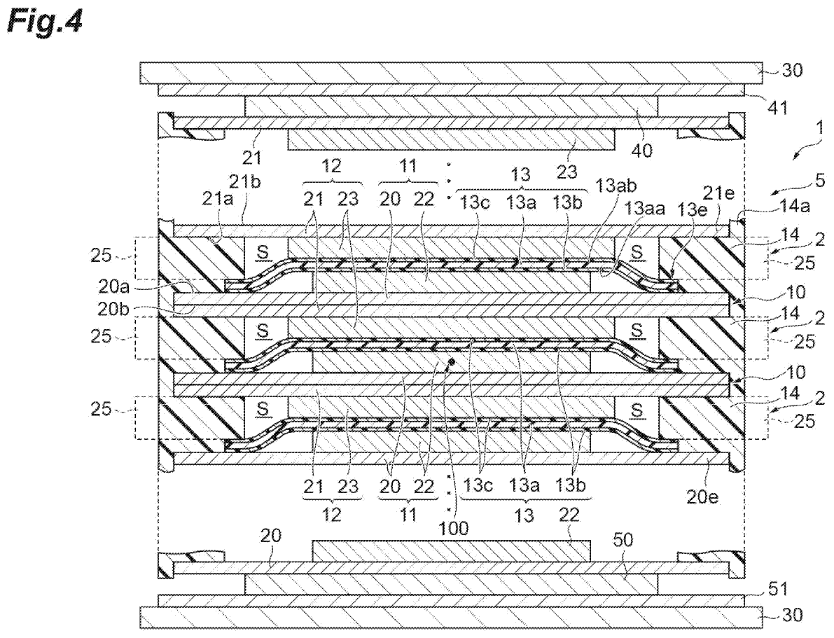

(a) to (d) of FIG. 3 and FIG. 4 are sectional views illustrating each step of a method for manufacturing the power storage device of the first embodiment. The power storage device 1, for example, can be manufactured as follows.

(Preparation of Positive Electrode Unit)

First, as illustrated in (a) of FIG. 3, a positive electrode unit U1 is prepared. The positive electrode unit U1 includes the positive electrode 11 (a first electrode) that includes the first current collector 20, and the positive electrode active material layer 22 (a first active material layer) provided on one surface 20a of the first current collector 20. In the first embodiment, the positive electrode unit U1 includes the separator 13 that is provided on one surface 20a of the first current collector 20. The separator 13 is arranged to cover the positive electrode active material layer 22. The separator 13 includes the base material layer 13a, the first adhesive layer 13b provided on the first surface 13aa of the base material layer 13a, and the second adhesive layer 13c provided on the second surface 13ab of the base material layer 13a. The first adhesive layer 13b in the edge portion 13e of the separator 13 is arranged to face one surface 20a of the first current collector 20. In this step, the first adhesive layer 13b in the edge portion 13e of the separator 13 may adhere to one surface 20a of the first current collector 20. In a case where a thermosetting adhesive is contained in the first adhesive layer 13b and the second adhesive layer 13c of the separator 13, the thermosetting adhesive has adhesiveness even in an uncured state. Accordingly, the edge portion 13e of the separator 13 adheres to one surface 20a of the first current collector 20 via the adhesive layer to be fixed.

The temperature sensor 101 is embedded in the positive electrode active material layer 22 of a part of the positive electrode units U1 together with the lead wire 102 (refer to (c) of FIG. 3). The temperature sensor 101 and the lead wire 102 may be arranged to be embedded in the positive electrode active material layer 22 by mounting the temperature sensor 101 and the lead wire 102 on one surface 20a of the first current collector 20, and then, by forming the positive electrode active material layer 22 on the temperature sensor 101 and the lead wire 102. In addition, the positive electrode active material layer 22 may be formed on one surface 20a of the first current collector 20, and then, the temperature sensor 101 and the lead wire 102 may be arranged on the positive electrode active material layer 22, and the separator 13 may be further arranged on the temperature sensor 101 and the lead wire 102. In addition, the temperature sensor 101 and the lead wire 102 may be embedded in the positive electrode active material layer 22 when forming the positive electrode active material layer 22 on one surface 20a of the first current collector 20.

(Preparation of Negative Electrode Unit)

As illustrated in (b) of FIG. 3, a negative electrode unit U2 is prepared. The negative electrode unit U2 includes the negative electrode 12 (a second electrode having polarity different from that of the first electrode) that includes the second current collector 21, and the negative electrode active material layer 23 (a second active material layer) provided on one surface 21a of the second current collector 21, and the resin frame 25 welded to the edge portion 21e of the second current collector 21.

In this embodiment, in the preparation step of the positive electrode unit U1, the positive electrode unit U1 is prepared by arranging the separator 13 on the positive electrode active material layer 22 formed on the first current collector 20, but a method for arranging the separator 13 is not limited thereto. The separator 13 may not be provided in the positive electrode unit U1. For example, in the preparation step of the negative electrode unit U2, the negative electrode unit U2 may be prepared by arranging the separator 13 on the negative electrode active material layer 23 formed on the second current collector 21. In addition, in both of the preparation step of the positive electrode unit U1 and the preparation step of the negative electrode unit U2, the separator 13 may not be provided. For example, in a stacking step of the positive electrode unit U1 and the negative electrode unit U2 described below, the separator 13 may be arranged between the positive electrode unit U1 and the negative electrode unit U2.

(Stacking of Positive Electrode Unit and Negative Electrode Unit)

Next, as illustrated in (c) of FIG. 3, the positive electrode unit U1 and the negative electrode unit U2 are alternately stacked. In this case, the negative electrode active material layer 23 faces the positive electrode active material layer 22 via the separator 13. The edge portion 13e of the separator 13 is arranged between one surface 20a of the first current collector 20 and the resin frame 25. The first adhesive layer 13b in the edge portion 13e of the separator 13 faces one surface 20a of the first current collector 20. Then, another negative electrode unit U2 is stacked on the positive electrode unit U1 such that the other surface 20b of the first current collector 20 of the positive electrode unit U1 stacked on the negative electrode unit U2 is in contact with the other surface 21b of the second current collector 21 of another negative electrode unit U2. The second adhesive layer 13c in the edge portion 13e of the separator 13 faces the resin frame 25. A plurality of resin frames 25 are arranged to be separated from each other in the stacking direction of the positive electrode unit U1 and the negative electrode unit U2.

(Formation of Sealing Portion)

Next, as illustrated in (d) of FIG. 3, the resin frame 25 interposed between the first current collector 20 of the positive electrode unit U1 and the second current collector 21 of the negative electrode unit U2 is welded to the edge portion 20e of the first current collector 20. Accordingly, the resin sealing portion 14 sealing the space S between the positive electrode 11 and the negative electrode 12 is formed. In this case, a part of the lead wire 102 connected to the temperature sensing unit 100 is embedded in the resin frame 25. After that, the resin frames 25 adjacent to each other in the stacking direction of the positive electrode unit U1 and the negative electrode unit U2 may be welded. In the case of welding the resin frames 25, for example, the adjacent resin frames 25 are welded by pressing a heat plate against an outer circumferential surface 25s of each of the resin frames 25.

(Initial Charge/Discharge of Power Storage Device)

Next, as illustrated in FIG. 4, initial charge/discharge of the power storage device 1 including the positive electrode 11, the negative electrode 12, and the separator 13 is performed (an activation step). In the first embodiment, the initial charge/discharge is performed in a state where the positive electrode 11, the negative electrode 12, and the separator 13 are restrained in the stacking direction. In the stacking direction, the power storage device 1 is restrained by interposing the power storage device 1 between a pair of restraint members 30. A positive electrode collector plate 40 that is electrically connected to the first current collector 20 is arranged between one restraint member 30 and the first current collector 20 arranged on one end in the stacking direction. An insulating plate 41 is arranged between one positive electrode collector plate 40 and one restraint member 30. A negative electrode collector plate 50 that is electrically connected to the second current collector 21 is arranged between the other restraint member 30 and the second current collector 21 arranged on the other end in the stacking direction. An insulating plate 51 is arranged between the negative electrode collector plate 50 and the other restraint member 30.

The initial charge/discharge of the power storage device 1, for example, may be performed by arranging the power storage device 1 restrained by the pair of restraint members 30 in a thermostatic bath, and by connecting the wiring of a power source to the positive electrode collector plate 40 and the negative electrode collector plate 50.

After the activation step, the restraint by the pair of restraint members 30 is released, and the power storage device 1 is taken out. As described above, the power storage device 1 can be manufactured. The lead wire 102 drawn outside from the power storage device 1 is connected to an external control device or the like for monitoring the temperature of the power storage device 1.

Hereinafter, a function effect of the power storage device 1 according to the first embodiment will be described. For example, in a case where a coating area of the active material layer when seen from the stacking direction is large, it is also difficult to precisely measure a temperature difference in the active material. In contrast, in the first embodiment, the temperature sensor 101 is arranged inside from the sealing body 14a when seen from the stacking direction and inside the predetermined power storage cell 2 included in the cell stack 5. Accordingly, the temperature sensor 101 is capable of precisely measuring the internal temperature of the predetermined power storage cell 2 when the power storage device 1 is used. In addition, the temperature sensor 101 is arranged between one end and the other end of the cell stack 5 in the stacking direction. Accordingly, for example, it is also possible to precisely measure the internal temperature of the power storage cell 2 positioned on the center side of the cell stack 5 in the stacking direction when used. Therefore, according to the first embodiment, it is possible to promptly sense whether there is temperature abnormality in the power storage device 1.

In the first embodiment, the power storage device 1 is provided with the power storage cell 2 including the positive electrode 11 that includes the first current collector 20, and the positive electrode active material layer 22 provided on one surface 20a of the first current collector 20, the negative electrode 12 that includes the second current collector 21, and the negative electrode active material layer 23 provided on one surface 21a of the second current collector 21, and is arranged such that the negative electrode active material layer 23 faces the positive electrode active material layer 22 in the stacking direction, and the separator 13 that is arranged between the positive electrode 11 and the negative electrode 12, and the temperature sensor 101 is arranged in the space S sealed by the sealing portion 14, the first current collector 20, and the second current collector 21. Accordingly, the temperature sensor 101 is capable of precisely measuring the internal temperature of the power storage cell 2 to be measured by the temperature sensor 101.

In the first embodiment, the temperature sensor 101 is embedded in the positive electrode active material layer 22. Accordingly, since the movement of the temperature sensor 101 due to an impact or the like on the power storage device 1 is suppressed, the temperature sensor 101 and the first current collector 20 are less likely to cause friction. Therefore, it is possible to suppress a damage to the first current collector 20 due to the temperature sensor 101.

In the first embodiment, at least a part of the temperature sensor 101 is arranged in the center region of the cell stack 5 when seen from the stacking direction. Accordingly, it is possible to more precisely measure the internal temperature of the power storage cell 2 to be measured by the temperature sensor 101.

In the first embodiment, the power storage device 1 is provided with the lead wire 102 that includes the FPC and is electrically connected to the temperature sensor 101, the temperature sensor 101 is provided on one end of the lead wire 102, and the other end of the lead wire 102 is connected to the control circuit arranged outside the cell stack 5. Accordingly, it is possible to transmit the measurement result of the temperature sensor 101 to the control circuit positioned outside the cell stack 5.

In the first embodiment, the lead wire 102 includes the conductive foil 102a that is the conductive portion connected to the temperature sensor 101, and the base film 102b that is the insulating portion covering the conductive foil 102a, and the temperature sensor 101 is covered with the base film 102b. Accordingly, it is possible to suppress the malfunction of the temperature sensor 101.

Hereinafter, modification examples of the first embodiment described above will be described. In the following modification examples, the description of the overlapping parts with the first embodiment described above will be omitted. Therefore, hereinafter, parts different from the first embodiment described above will be mainly described.

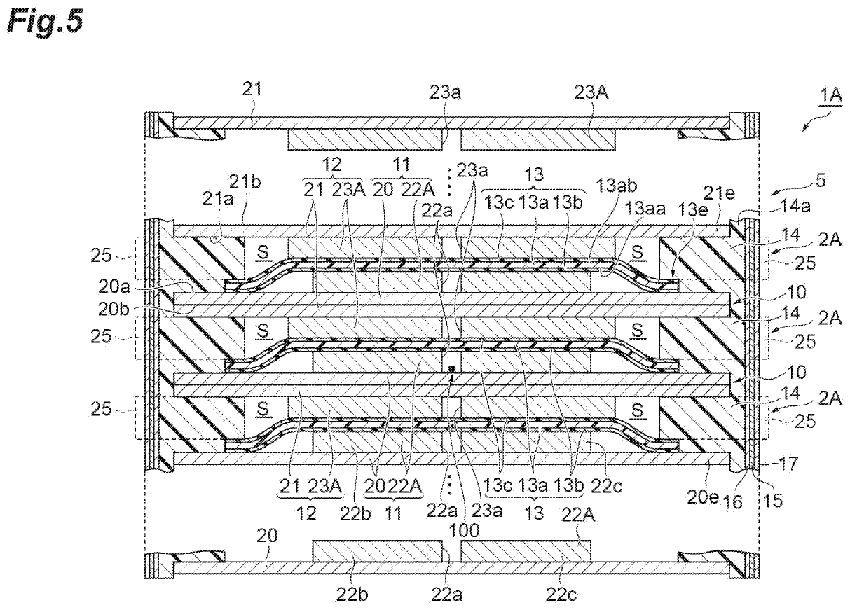

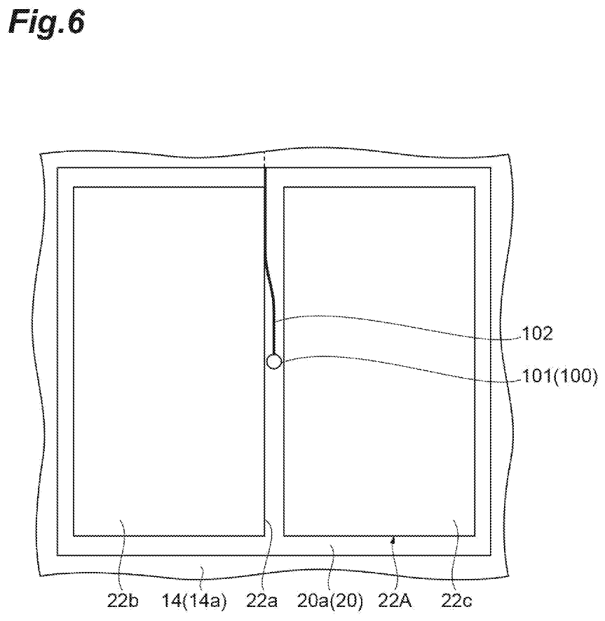

FIG. 5 is a schematic sectional view illustrating a power storage device according to a first modification example. FIG. 6 is a plan view illustrating a part of a cell stack according to the first modification example. As illustrated in FIG. 5 and FIG. 6, a power storage device 1A according to the first modification example includes a power storage cells 2A. A groove 22a extending in a direction intersecting with the stacking direction (hereinafter, referred to as an “intersecting direction”) is provided in a positive electrode active material layer 22A of the power storage cell 2A. The groove 22a extends from one end to the other end of the positive electrode active material layer 22A in the intersecting direction. The bottom surface of the groove 22a is formed by the first current collector 20. Accordingly, the positive electrode active material layer 22A is divided into two portions 22b and 22c by the groove 22a. In the first modification example, the groove 22a overlaps with the center of the first current collector 20 when seen from the stacking direction, but is not limited thereto. In a case where a plurality of grooves 22a are provided in the positive electrode active material layer 22A, any one of the grooves 22a may overlap with the center of the first current collector, or all of the grooves 22a may overlap with the center.

Similarly, a groove 23a extending in the intersecting direction is provided in a negative electrode active material layer 23A. The groove 23a extends from one end to the other end of the negative electrode active material layer 23A in the intersecting direction. The bottom surface of the groove 23a is formed by the second current collector 21. Accordingly, the negative electrode active material layer 23A is divided into two portions by the groove 23a. The groove 23a overlaps with the groove 22a in the stacking direction. In the first modification example, the width of the groove 23a is less than or equal to the width of the groove 22a.

In the first modification example, the temperature sensing unit 100 is contained in the groove 22a. The temperature sensing unit 100 is in contact with a portion defining the groove 22a in the center portion of the positive electrode active material layer 22A. The temperature sensor 101 is in contact with the first current collector 20 in the groove 22a. In the first modification example, a part of the lead wire 102 is in contact with the portion defining the groove 22a in the positive electrode active material layer 22A. When seen from the stacking direction, the lead wire 102 may be in contact with both of two portions 22b and 22c of the positive electrode active material layer 22A and the first current collector 20. Note that, the center portion of the positive electrode active material layer 22A, for example, corresponds to a portion overlapping with the center region of the cell stack 5 in the stacking direction.

A metal layer 15 may be formed on the surface (the outer circumferential surface) of the sealing portion 14. The metal layer 15 extends in the stacking direction from the first current collector 20 arranged on one end of the cell stack 5 in the stacking direction to the second current collector 21 arranged on the other end in the stacking direction. The metal layer 15, for example, may be attached to the surface of the sealing portion 14 via an adhesive layer 16. In addition, the metal layer 15 may be directly formed on the surface of the sealing portion 14 without the adhesive layer 16. In this case, for example, the metal layer 15 may be formed by vapor deposition, or the metal layer 15 may be formed by welding a metal foil to the surface of the sealing portion 14. Further, an insulating layer 17 may be further formed on the surface of the metal layer 15. The insulating layer 17, for example, contains an insulating resin.

In the first modification example described above, the same function effect as that of the first embodiment described above is also obtained. In addition, a part of the groove 22a may overlap with the negative electrode active material layer 23A, but the groove 23a does not overlap with the positive electrode active material layer 22A.

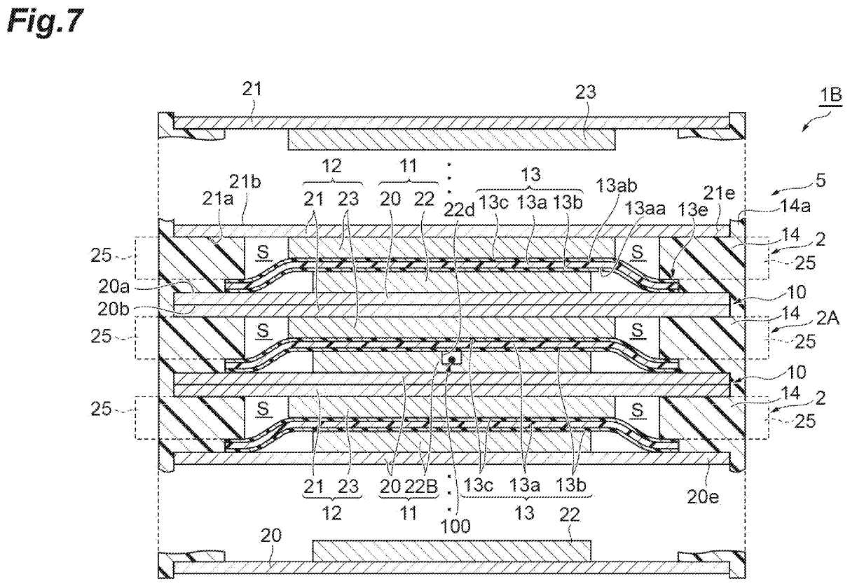

FIG. 7 is a schematic sectional view illustrating a power storage device according to a second modification example. As illustrated in FIG. 7, a power storage device 1B according to the second modification example includes a power storage cells 2, and one or a power storage cells 2B. A positive electrode active material layer 22B of the power storage cell 2B includes a concave portion 22d that is recessed toward the first current collector 20 in the stacking direction. The concave portion 22d is defined by the positive electrode active material layer 22B. Accordingly, both lateral surfaces and the bottom surface of the concave portion 22d are formed by the positive electrode active material layer 22B. The concave portion 22d, for example, extends from one end to the other end of the positive electrode active material layer 22B in the intersecting direction, but is not limited thereto. The concave portion 22d overlaps with the negative electrode active material layer 23 in the stacking direction. When seen from the intersecting direction, the concave portion 22d is approximately in the shape of a rectangle. The depth of the concave portion 22d in the stacking direction, for example, is 50% or more and 90% or less of the thickness of the positive electrode active material layer 22B in the stacking direction.

In the second modification example, the temperature sensing unit 100 included in the power storage cell 2B is positioned between a positive electrode 11B and the negative electrode 12 in the stacking direction. In addition, the temperature sensing unit 100 is contained in the concave portion 22d. The temperature sensing unit 100 is in contact with a portion defining the concave portion 22d in the center portion of the positive electrode active material layer 22B. When seen from the stacking direction, the lead wire 102 may be in contact with the both lateral surfaces of the concave portion 22d.

In the second modification example described above, the same function effect as that of the first embodiment described above is also obtained. In addition, since the temperature sensing unit 100 is directly in contact with the positive electrode active material layer 22B, it is possible to precisely measure the temperature of the positive electrode active material layer 22B.

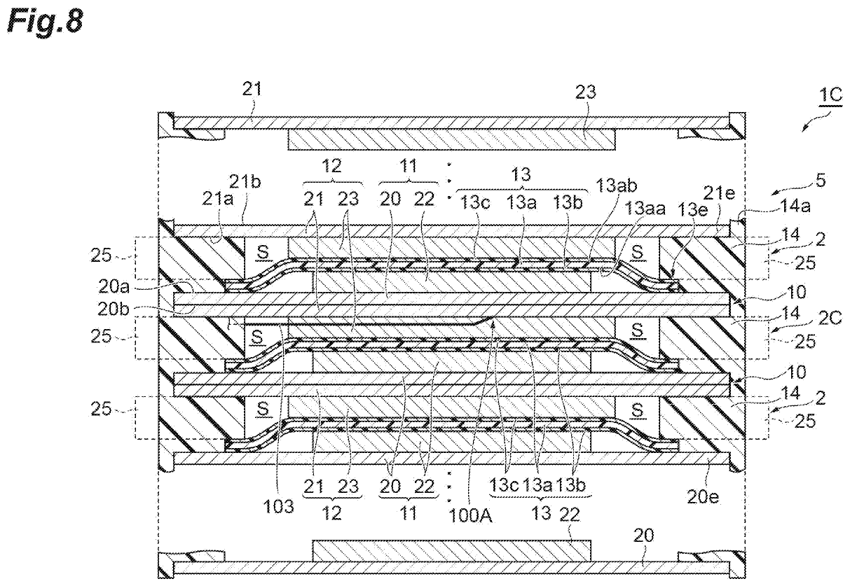

FIG. 8 is a schematic sectional view illustrating a power storage device according to a third modification example. As illustrated in FIG. 8, a power storage device 1C according to the third modification example includes a power storage cells 2, and one or a power storage cells 2C. The surface of the second current collector 21 included in the power storage cell 2C contains copper. In addition, the power storage cell 2C includes a constantan wire 103. One end of the constantan wire 103 is embedded in the positive electrode active material layer 22 and is in contact with the surface of the second current collector 21. In the third modification example, a thermocouple is formed by the surface of the second current collector 21 and the constantan wire 103. In the third modification example, a temperature sensing unit 100A (and a temperature sensor) included in the power storage cell 2C is formed by the surface of the second current collector 21 and one end of the constantan wire 103.

In the third modification example described above, the same function effect as that of the first embodiment described above is also obtained. In addition, since the temperature sensing unit 100A is formed by the surface of the second current collector 21 and the constantan wire 103, it is possible to simplify the configuration of the temperature sensing unit 100A in the power storage cell 2C. In addition, it is possible to reduce the number of extraction wirings from the power storage device 1C.

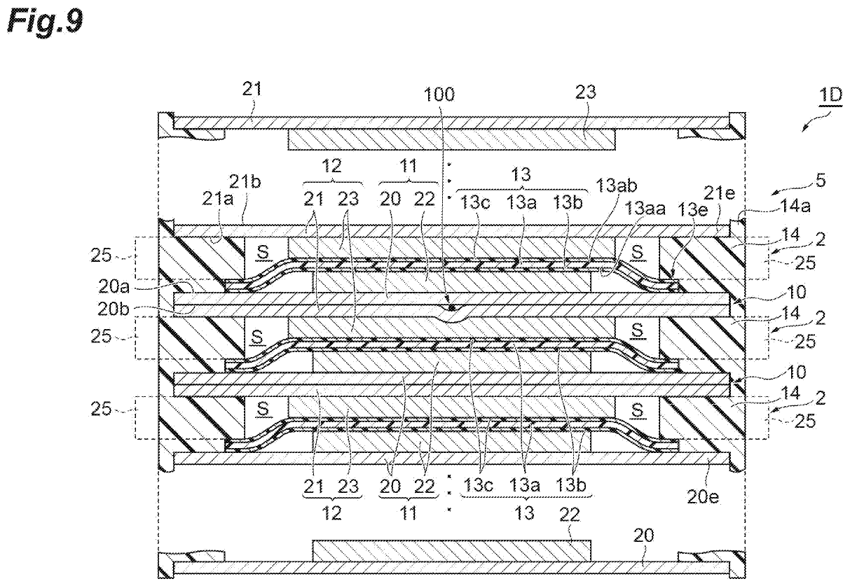

FIG. 9 is a schematic sectional view illustrating a power storage device according to a fourth modification example. As illustrated in FIG. 9, the temperature sensing unit 100 of a power storage device 1D according to the fourth modification example is arranged between two power storage cells 2 and 2 adjacent to each other along the stacking direction, in the center region of the cell stack 5 when seen from the stacking direction. More specifically, the temperature sensing unit 100 is interposed between the center portion of the second current collector 21 of one power storage cell 2 (a first power storage cell) and the center portion of the first current collector 20 of the other power storage cell 2 (a second power storage cell). The temperature sensing unit 100 can be in contact with the second current collector 21 of one power storage cell 2 and the first current collector 20 of the other power storage cell 2. In the stacking direction, a portion of the second current collector 21 included in one power storage cell 2, which overlaps with the temperature sensing unit 100, is recessed toward the negative electrode active material layer 23. In the fourth modification example, the portion of the second current collector 21 of one power storage cell 2, which overlaps with at least the temperature sensor 101, is recessed toward the negative electrode active material layer 23, in the stacking direction. The temperature sensor 101 is contained in the recess that is provided in the second current collector 21 described above. Note that, each of the center portion of the first current collector 20 and the center portion of the second current collector 21, for example, corresponds to the portion overlapping with the center region of the cell stack 5 in the stacking direction.

In the fourth modification example described above, the same function effect as that of the first embodiment described above is also obtained. In addition, it is possible to suppress a damage to the second current collector 21 of one power storage cell 2 and the first current collector 20 of the other power storage cell 2 due to the temperature sensor 101.

### Second Embodiment

Hereinafter, a power storage device according to a second embodiment will be described. In the second embodiment described below, the description of the overlapping parts with the first embodiment described above and each of the modification examples thereof will be omitted. Therefore, hereinafter, parts different from the first embodiment described above and each of the modification examples thereof will be mainly described.

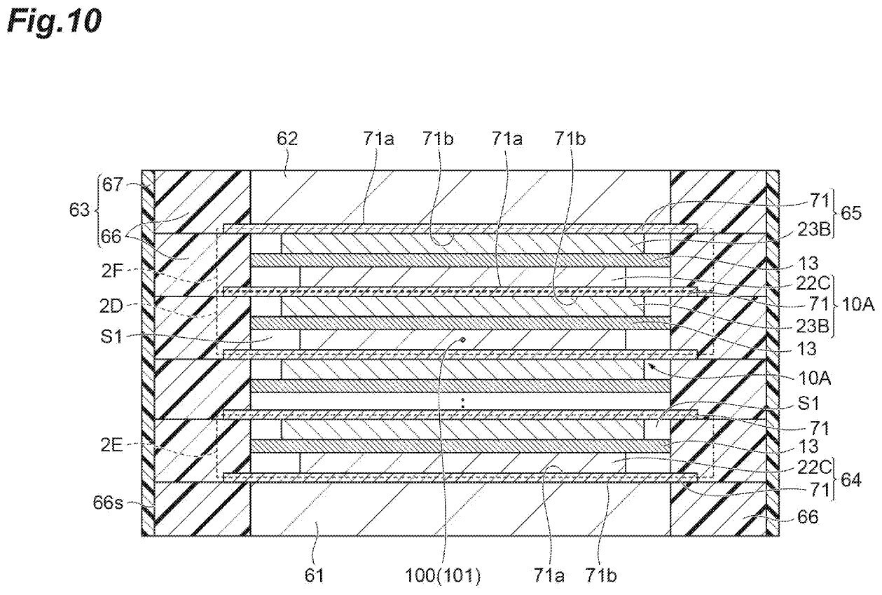

FIG. 10 is a schematic sectional view illustrating the power storage device according to the second embodiment. A power storage device 1E illustrated in FIG. 10 includes a cell stack 5A (a stacked body), a positive electrode collector plate 61, a negative electrode collector plate 62, a sealing body 63, and the temperature sensing unit 100. The cell stack 5A includes a plurality of bipolar electrodes 10A, a plurality of separators 13, a positive terminal electrode 64, and a negative terminal electrode 65. In the cell stack 5A, the bipolar electrode 10A and the separator 13 are alternately stacked. Accordingly, one separator 13 is arranged between two bipolar electrodes 10A and 10A (a first bipolar electrode and a second bipolar electrode) adjacent to each other in the stacking direction.

Each of the plurality of bipolar electrodes 10A includes a current collector 71, a positive electrode active material layer 22C provided on one surface 71a of the current collector 71, and a negative electrode active material layer 23B provided on the other surface 71b of the current collector 71. The current collector 71, for example, is a metal foil such as a nickel foil, a titanium foil, or a stainless steel foil. The surface of the current collector 71 may be subjected to a plating treatment. The thickness of the current collector 71, for example, is in a range of 1 μm to 100 μm. The positive electrode active material layer 22C and the negative electrode active material layer 23B are the same as the positive electrode active material layer 22 and the negative electrode active material layer 23 of the first embodiment described above, respectively. The negative electrode active material layer 23B is arranged to face the positive electrode active material layer 22C in the stacking direction. When seen from the stacking direction, the negative electrode active material layer 23B is formed to be slightly larger than the positive electrode active material layer 22C.

The positive terminal electrode 64 is provided on one end of the cell stack 5A in the stacking direction, and the negative terminal electrode 65 is provided on the other end of the cell stack 5A in the stacking direction. Each of the positive terminal electrode 64 and the negative terminal electrode 65 is stacked in the bipolar electrode 10A via the separator 13. The positive terminal electrode 64 includes the current collector 71 and the positive electrode active material layer 22C. The negative electrode active material layer 23B is not provided in the positive terminal electrode 64. The negative terminal electrode 65 includes the current collector 71 and the negative electrode active material layer 23B. The positive electrode active material layer 22C is not provided in the negative terminal electrode 65.

A power storage cells 2D in the second embodiment include two bipolar electrodes 10A adjacent to each other in the stacking direction, and one separator 13 positioned between the two bipolar electrodes 10A. More specifically, the power storage cell 2D is provided with the current collector 71 and the positive electrode active material layer 22C included in one bipolar electrode 10A, one separator 13, and the current collector 71 and the negative electrode active material layer 23B included in the other bipolar electrode 10A. Accordingly, in the second embodiment, among the power storage cells 2D included in the cell stack 5A, two power storage cells 2D adjacent to each other in the stacking direction share one bipolar electrode 10A. For example, in one bipolar electrode 10A, the current collector 71 and the positive electrode active material layer 22C are included in one power storage cell 2D, and the current collector 71 and the negative electrode active material layer 23B are included in the other power storage cell 2D. In addition, a power storage cell 2E in the second embodiment includes a current collector 71A and the negative electrode active material layer 23B of the bipolar electrode 10A closest to the positive terminal electrode 64 in the stacking direction, the separator 13, and the positive terminal electrode 64. A power storage cell 2F in the second embodiment includes the current collector 71A and the positive electrode active material layer 22C of the bipolar electrode 10A closest to the negative terminal electrode 65 in the stacking direction, the separator 13, and the negative terminal electrode 65.

The positive electrode collector plate 61 is a conductive member that is in contact with the cell stack 5A, and is in the shape of a plate. The positive electrode collector plate 61 is in contact with the positive terminal electrode 64. The negative electrode collector plate 62 is a conductive member that is in contact with the cell stack 5A, and is in the shape of a plate. The negative electrode collector plate 62 is in contact with the negative terminal electrode 65.

The sealing body 63 is a sealing member retaining the plurality of bipolar electrodes 10A, the plurality of separators 13, the positive terminal electrode 64, and the negative terminal electrode 65, which are included in the cell stack 5A, and has insulating properties. The sealing body 63 extends from one end to the other end of the cell stack 5A in the stacking direction, and seals the cell stack 5A. The sealing body 63 includes a plurality of sealing portions 66, and an insulating outermost film 67.

The sealing portion 66 is a resin member sealing a space S1 between two adjacent bipolar electrodes 10A and 10A. The sealing portion 66 is in the shape of a rectangular frame when seen from the stacking direction, and is welded to the edge portion of the current collector 71. The sealing portions 66 are integrated by surrounding the plurality of bipolar electrodes 10A and the plurality of separators 13 included in the cell stack 5A when seen from the stacking direction. In the first embodiment, by integrating the plurality of sealing portions 66 arranged in the stacking direction of the cell stack 5A, the sealing body 63 is formed. In the second embodiment, each of the positive electrode collector plate 61 and the negative electrode collector plate 62 is also surrounded by the sealing portion 66 when seen from the stacking direction.

The outermost film 67 is a member provided on the surface of each of the sealing portions 66, and has insulating properties. The outermost film 67 covers an outer surface 66s of each of the sealing portions 66. Accordingly, it is possible to improve the insulating properties of the outer surface 66s. The outermost film 67, for example, is formed by applying a coating material to the outer surface 66s, and then, by drying the coating material. The coating material, for example, is a material in which a synthetic resin having insulating properties is dissolved in an organic solvent, and the like. When a plurality of power storage devices 1E are stacked along the stacking direction, the outermost film 67 may be collectively provided over the plurality of power storage devices 1E.

In the second embodiment, the temperature sensor 101 of the temperature sensing unit 100 is arranged between two bipolar electrodes 10A and 10A adjacent to each other in the stacking direction, among the plurality of bipolar electrodes 10A included in the cell stack 5A. For example, the temperature sensor 101 is arranged in the space S1 sealed by the current collector 71 (a first current collector) of one bipolar electrode 10A of two bipolar electrodes 10A and 10A described above, the current collector 71 (a second current collector) of the other bipolar electrode 10A, and the sealing portion 66 interposed between two bipolar electrodes 10A and 10A described above. Alternatively, the temperature sensor 101 is arranged inside any one of the power storage cells 2D to 2F. In the second embodiment, from the viewpoint of suppressing a decrease in the capacity of the negative electrode active material layer 23B, the temperature sensor 101 is embedded in the center portion of the positive electrode active material layer 22C of one bipolar electrode 10A when seen from the stacking direction. Even though it is not illustrated, the temperature sensor 101 is connected to the lead wire.

In the power storage device 1E of the second embodiment described above, the temperature sensing unit 100s is arranged in the center portion of the space S sealed by the sealing portion 66 and two bipolar electrodes 10A and 10A. Therefore, in the second embodiment, the temperature sensing unit 100 is capable of precisely measuring the internal temperature of the power storage device 1E. In addition, by arranging two bipolar electrodes 10A and 10A, for example, on the center of the cell stack 5A or in the vicinity thereof, it is possible to precisely measure a temperature difference between the bipolar electrode 10A positioned on the end in the stacking direction and the bipolar electrode 10A positioned on the center side in the stacking direction.

### Third Embodiment

Hereinafter, a power storage device according to a third embodiment will be described. In the third embodiment described below, the description of the overlapping parts with the first embodiment described above and each of the modification examples thereof, and the second embodiment described above will be omitted. Therefore, hereinafter, parts different from the first embodiment described above and each of the modification examples thereof, and the second embodiment described above will be mainly described.

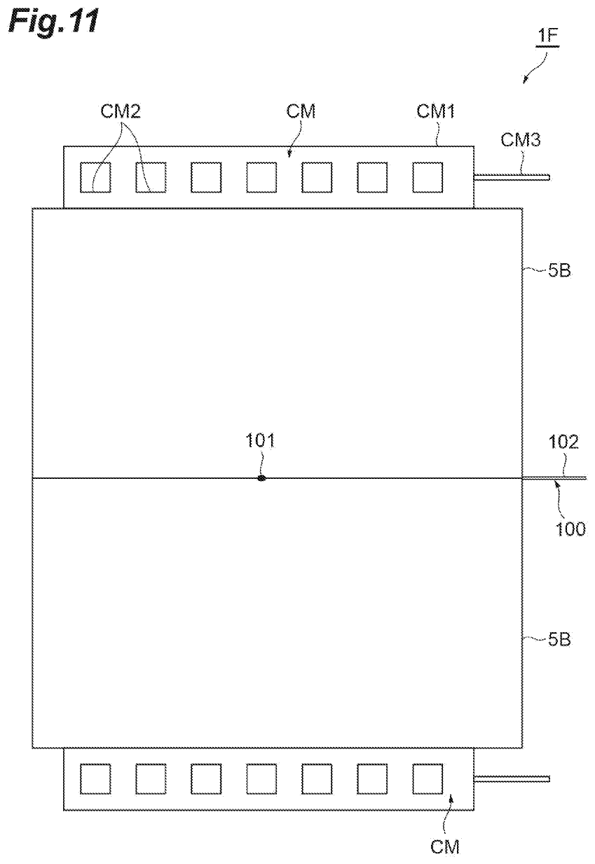

FIG. 11 is a schematic sectional view illustrating the power storage device according to the third embodiment. As illustrated in FIG. 11, a power storage device 1F includes two cell stacks 5B (a first stacked body and a second stacked body) adjacent to each other in the stacking direction, a pair of cooling members CM (a first cooler and a second cooler), and the temperature sensing unit 100. In addition, even though it is not illustrated, the power storage device 1F includes a pair of restraint members restraining two cell stacks 5B and the pair of cooling members CM in the stacking direction. The structures of two cell stacks 5B are identical to each other. Accordingly, hereinafter, the structure of one cell stack 5B will be described.

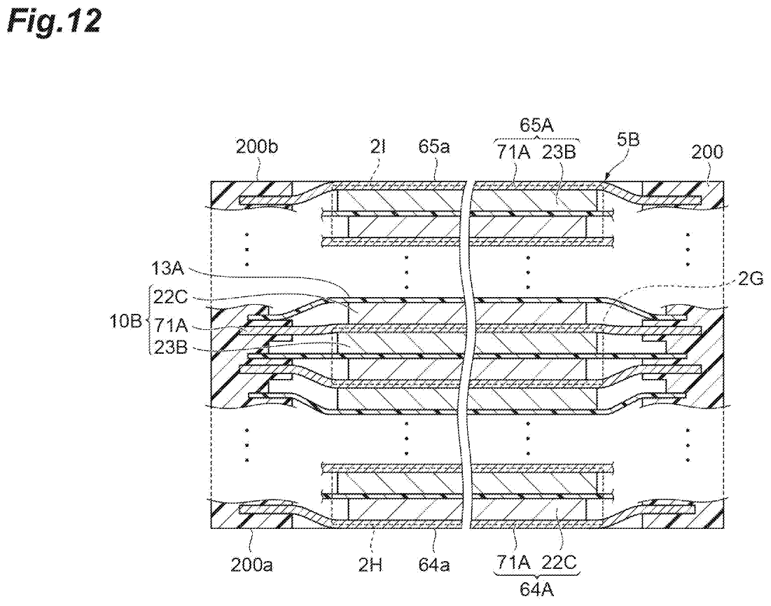

FIG. 12 is a schematic sectional view illustrating the cell stack according to the third embodiment. As illustrated in FIG. 12, the cell stack 5B includes a plurality of bipolar electrodes 10B, a plurality of separators 13A, a positive terminal electrode 64A, and a negative terminal electrode 65B. Each of the plurality of bipolar electrodes 10B includes the current collector 71A, a positive electrode active material layer 22C, and the negative electrode active material layer 23B. In the third embodiment, each of the plurality of separators 13A has a single-layer structure, but is not limited thereto. The circumferential edge portions of at least some separators 13A may be bent. The positive terminal electrode 64A includes the current collector 71A and the positive electrode active material layer 22C. The negative terminal electrode 65A includes the current collector 71A and the negative electrode active material layer 23B. The circumferential edge portions of at least some current collectors 71A among all the current collectors 71A described above may be bent.

Each of the cell stacks 5B includes two or more power storage cells. A power storage cells 2G in the third embodiment includes two bipolar electrodes 10B adjacent to each other in the stacking direction, and one separator 13A positioned between the two bipolar electrodes 10B. More specifically, the power storage cell 2G is provided with the current collector 71A and the positive electrode active material layer 22C included in one bipolar electrode 10B, one separator 13A, and the current collector 71A and the negative electrode active material layer 23B included in the other bipolar electrode 10B. In addition, a power storage cell 2H in the third embodiment includes the bipolar electrode 10B closest to the positive terminal electrode 64A in the stacking direction, the separator 13A, and the positive terminal electrode 64A. A power storage cell 21 in the third embodiment includes the bipolar electrode 10B closest to the negative terminal electrode 65A in the stacking direction, the separator 13A, and the negative terminal electrode 65A.

The cell stack 5B is sealed by a sealing body 200. The sealing body 200 is a member having the same structure and function as that of the sealing body 63 of the second embodiment described above, and has insulating properties. The sealing body 200 is in the shape of a rectangular frame when seen from the stacking direction, and is welded to the edge portion of the current collector 71A. The sealing body 200 extends from one end to the other end of the cell stack 5B in the stacking direction, and seals the cell stack 5B. The sealing bodies 200 sealing two adjacent cell stacks 5B, respectively, are separated from each other. A part of the inner surface of the sealing body 200 may protrude along the current collector 71A. In this case, the circumferential edge portion of the separator 13A is arranged on the protrusion of the inner surface. In addition, the circumferential edge portions of at least some separators 13A of the plurality of separators 13A may be embedded in the sealing body 200. In the third embodiment, one end surface 200a of the sealing body 200 orthogonal to the stacking direction is aligned with an end surface 64a of the positive terminal electrode 64A, and the other end surface 200b of the sealing body 200 orthogonal to the stacking direction is aligned with an end surface 65a of the negative terminal electrode 65A.

Returning to FIG. 11, the temperature sensor 101 of the temperature sensing unit 100 is arranged between two cell stacks 5B in the stacking direction. In the third embodiment, the power storage cell (a first power storage cell) included in one cell stack 5B (a first stacked body) is in contact with the temperature sensor 101. In addition, the power storage cell (a second power storage cell) that is included in the other cell stack 5B (a second stacked body) and is adjacent to the first power storage cell is in contact with the temperature sensor 101. In the third embodiment, the current collector 71A of the first power storage cell is the positive terminal electrode that is arranged on one end of the first stacked body in the stacking direction, and the current collector 71A of the second power storage cell is the negative terminal electrode that is arranged on one end of the second stacked body in the stacking direction. Accordingly, the first power storage cell corresponds to the power storage cell 2H illustrated in FIG. 12, the second power storage cell corresponds to the power storage cell 21 illustrated in FIG. 12, and the temperature sensor 101 is arranged between the positive terminal electrode of the first power storage cell and the negative terminal electrode of the second power storage cell.

The pair of cooling members CM are a member suppressing an increase in the temperature of the power storage device 1F, and for example, contains a metal. One cooling member CM (a first cooler) is positioned on one end of the power storage device 1F in the stacking direction, and is in contact with the positive terminal electrode of the one cell stack 5B. The other cooling member CM is positioned on the other end of the power storage device 1F in the stacking direction, and is in contact with the negative terminal electrode of the other cell stack 5B. In other words, the first cooler is in contact with the other end of the first stacked body in the stacking direction, and the second cooler is in contact with the other end of the second stacked body in the stacking direction. More specifically, the first cooler is in contact with the negative terminal electrode 65A of the first stacked body, and the second cooler is in contact with the positive terminal electrode 64A of the second stacked body. Each of the cooling members CM is also in contact with the sealing body 200.

Each of the pair of cooling members CM includes a main body CM1, a cooling flow path CM2, and a detection wire CM3. The main body CM1 has conductivity, and for example, is in the shape of a rectangular plate. The cooling flow path CM2 is a through hole formed in the main body CM1, and enables cooling fluid such as the air to pass through. The cooling flow path CM2 extends in a direction orthogonal to the stacking direction, but is not limited thereto. The cooling flow path CM2 may be meandering, or may extend in a direction intersecting with the stacking direction. In the main body CM1, a plurality of cooling flow paths CM2 are provided. As an example, the plurality of cooling flow paths CM2 may be formed in parallel to each other at an equal interval. The detection wire CM3 is provided on one end of the main body CM1, and is electrically connected to the main body CM1.

As described above, each of the cooling members CM includes the cooling flow path CM2 inside a conductive plate member (the main body CM1), and is abutted on and electrically connected to the positive terminal electrode 64A or the negative terminal electrode 65A. For example, it is possible to detect a battery state (for example, the voltage) of the power storage cell 21 including the negative terminal electrode 65A, and the bipolar electrode 10B adjacent to the negative terminal electrode 65A by using the detection wire CM3 of one cooling member CM, and a detection wire (not illustrated) connected to the current collector 71A of the bipolar electrode 10B adjacent to the negative terminal electrode 65A. Similarly, it is possible to detect a battery state (for example, the voltage) of the power storage cell 2H by using the detection wire CM3 of the other cooling member CM, and a detection wire (not illustrated) connected to the current collector 81A of the bipolar electrode 10B adjacent to the positive terminal electrode 64A. Therefore, the detection wire CM3 can be used to detect the battery state of the power storage cell. Each of the cooling members CM has a function of transmitting a restraint load on the corresponding cell stack 5B. In the third embodiment, the cooling member CM extends from the center portion of the current collector 71A to the circumferential edge portion of the current collector 71A to overlap with the sealing body 200 when seen from the stacking direction.

In the power storage device 1F of the third embodiment described above, the temperature sensing unit 100 is arranged between two cell stacks 5B (that is, on the center portion of the power storage device 1F in the stacking direction). Therefore, in the third embodiment, the temperature sensing unit 100 is capable of precisely measuring the internal temperature of the power storage device 1F. In addition, by using a plurality of temperature sensing units 100, for example, it is possible to precisely measure a temperature difference between the center portion of the power storage device 1F in the stacking direction and one end of the power storage device 1F in the stacking direction. In addition, each of the cell stacks 5B is sealed by the sealing body 200. Accordingly, it is possible to arrange the temperature sensor 101 without impairing sealing properties of each of the cell stacks 5B.

In the third embodiment described above, the power storage device 1F includes the cooling member CM. Accordingly, it is possible to precisely measure the internal temperature of a desired cell stack 5B by the temperature sensor 101 while adequately maintaining the temperature of the power storage device 1F.

Hereinafter, a modification example of the third embodiment described above will be described. In the following modification example, the description of the overlapping parts with the third embodiment described above will be omitted. Therefore, hereinafter, parts different from the third embodiment described above will be mainly described.

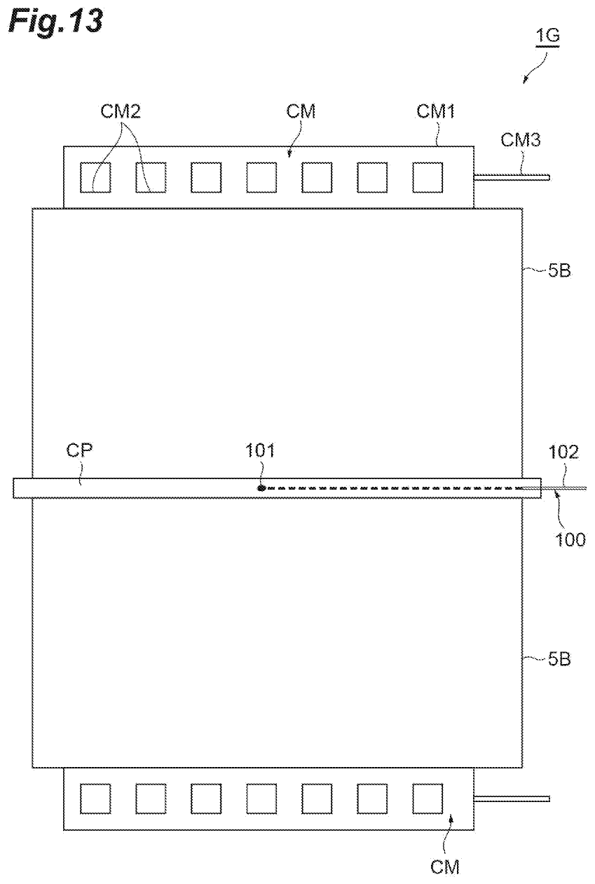

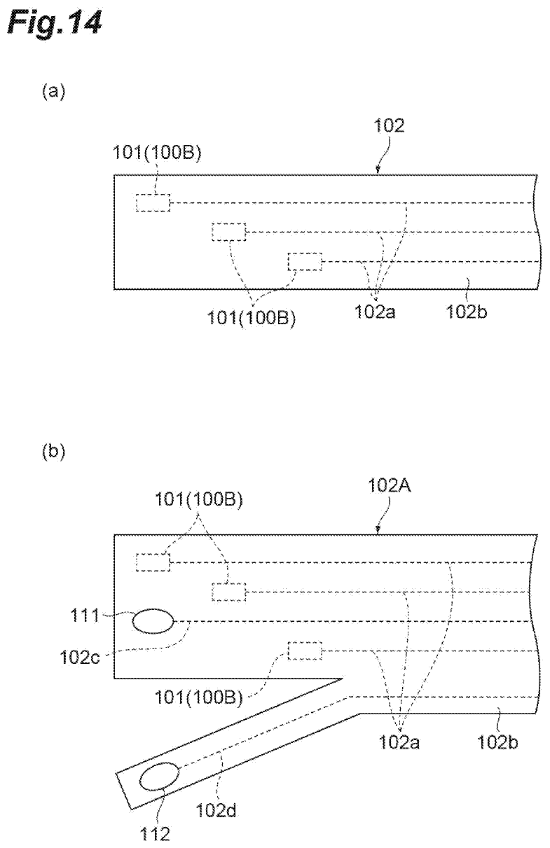

FIG. 13 is a schematic sectional view illustrating a power storage device according to the modification example of the third embodiment. As illustrated in FIG. 13, a power storage device 1G is different from the power storage device 1F described above in that a conductive plate CP positioned between two cell stacks 5B is further provided. The conductive plate CP is a member that electrically connects two cell stacks 5B, and for example, is a metal plate or an alloy plate in the shape of a rectangular plate. When seen from the stacking direction, the circumferential edge portion of the conductive plate CP is positioned outside from the cell stack 5B, but is not limited thereto. A pair of main surfaces included in the conductive plate CP are each in the shape of a flat surface. One main surface is in contact with one end of one cell stack 5B, and the other main surface is in contact with the other end of the other cell stack 5B.

The temperature sensor 101 of the temperature sensing unit 100 is arranged inside the conductive plate CP and/or on the surface of the conductive plate CP. In a case where the temperature sensor 101 is arranged inside the conductive plate CP, the conductive plate CP may be a hollow member. In a case where the temperature sensor 101 is arranged on the surface of the conductive plate CP, the temperature sensor 101 may be embedded in the conductive plate CP. The temperature sensor 101 is arranged in the center region of the conductive plate CP when seen from the stacking direction. The temperature sensor 101 is in contact with at least one of two cell stacks 5B interposing the conductive plate CP therebetween.

In the modification example of the third embodiment described above, the same function effect as that of the third embodiment described above is also obtained. In addition, since the deformation of the cell stack 5B due to the presence of the temperature sensing unit 100 can be suppressed, it is possible to prevent a damage to the power storage device 1G due to the presence of the temperature sensing unit 100.

In the third embodiment described above and the modification example described above, the power storage device includes two cell stacks and the pair of cooling members, but is not limited thereto. For example, in a case where two cell stacks in contact with each other are set to one power storage assembly, the power storage device may include a plurality of power storage assemblies, and a plurality of cooling members. In this case, one cooling member is provided between two power storage assemblies adjacent to each other in the stacking direction. In other words, one cooling member can be shared between two adjacent power storage assemblies. Note that, the power storage device including the plurality of power storage assemblies may include a plurality of temperature sensing units.

As described above, each of the preferred embodiments and each of the modification examples of the present disclosure have been described in detail, but the present disclosure is not limited to the embodiments described above and the modification examples described above. The embodiments described above and the modification examples described above may be suitably combined. For example, the first embodiment described above and the second embodiment described above may be combined with each other. In this case, in the first embodiment described above, the outer surface of the sealing portion may be covered with the outermost film of the insulating resin. For example, the first embodiment described above and the first modification example described above may be combined with each other. In this case, in the first embodiment described above, the outer surface of the sealing portion may be covered with a metal film or the like. For example, the first modification example described above and the third modification example described above may be combined with each other. For example, the second embodiment described above and the first modification example described above or the second modification example described above may be combined with each other. In this case, in the second embodiment described above, the outer surface of the sealing portion may be covered with the metal layer, instead of the outermost film of the insulating resin. For example, the second embodiment described above and the third embodiment described above may be combined with each other. In this case, the temperature sensing unit may be provided both between two cell stacks and inside at least one cell stack.

In the embodiments described above and the modification examples described above, one surface of the first current collector includes an adhesive surface that adheres to the first adhesive layer in the edge portion of the separator, but is not limited thereto. For example, one surface of the second current collector may include an adhesive surface that adheres to the second adhesive layer in the edge portion of the separator. In this case, one surface of the second current collector includes a coating region that is coated with the negative electrode active material layer, and a non-coating region that is not coated with the negative electrode active material layer. In addition, the non-coating region is provided around the coating region, and includes the adhesive surface described above, and the sealing portion adheres to the first adhesive layer in the edge portion of the separator.

In the embodiments described above and the modification examples described above, the temperature sensing unit includes one temperature sensor, but is not limited thereto. (a) of FIG. 14 is a schematic plan view illustrating main parts of an example of the temperature sensing unit. A temperature sensing unit 100B illustrated in (a) of FIG. 14 includes a plurality of temperature sensors 101 for measuring a temperature distribution of the same power storage cell. Each of the plurality of temperature sensors 101 is electrically connected to the lead wire 102. Each of the temperature sensors 101, for example, is covered with the base film 102b (refer to (b) of FIG. 2) of the lead wire 102. The plurality of temperature sensors 101 are arranged to be separated from each other when seen from the stacking direction. As a specific example, the plurality of temperature sensors 101 are sequentially arranged along a longitudinal direction of the lead wire 102, and the adjacent temperature sensors 101 are separated from each other in the longitudinal direction described above. Accordingly, for example, when the plurality of temperature sensors 101 are arranged in the same space, the temperature sensing unit 100B is capable of sensing a temperature distribution in the space. One part of the plurality of temperature sensors 101 may be embedded in the positive electrode active material layer or the negative electrode active material layer, and the other part may be exposed from the positive electrode active material layer and the negative electrode active material layer. Alternatively, one part of the plurality of temperature sensors 101, for example, may be embedded in the sealing body.

Note that, in a case where the temperature sensing unit 100B includes the plurality of temperature sensors 101, a space or the like in which one part of the temperature sensors 101 is arranged and a space or the like in which the other part of the temperature sensors 101 is arranged may be different from each other. In this case, the first embodiment described above and the fourth modification example described above may be combined with each other, and the first modification example described above and the second modification example described above may be combined with each other.

(b) of FIG. 14 is a schematic plan view illustrating main parts of another example of the temperature sensing unit. As illustrated in (b) of FIG. 14, voltage measurement terminals 111 and 112 (a voltage detection unit) are provided on the lead wire 102A. The voltage measurement terminals 111 and 112 are connected to voltage sensing conductive portions 102c and 102d, respectively, and are exposed from the base film 102b. The voltage measurement terminal 111, for example, is in contact with a current collector included in a predetermined bipolar electrode (or a pseudo-bipolar electrode). The voltage measurement terminal 112, for example, is in contact with a current collector included in a bipolar electrode different from the predetermined bipolar electrode described above. Note that, by performing cutting processing with respect to a part of the lead wire 102A, the voltage measurement terminals 111 and 112 can be easily arranged in positions different from each other even in the case of being formed on the same substrate. By using such a lead wire 102A, it is possible to measure the voltage of any portion in the power storage device.

In the embodiments described above, the temperature sensing unit is embedded in the positive electrode active material layer, but is not limited thereto. The temperature sensing unit may be embedded in the negative electrode active material layer. In addition, in one part of the power storage cells included in the cell stack, the temperature sensing unit may be embedded in the positive electrode active material layer, and in the other part of the power storage cells, another temperature sensing unit may be embedded in the negative electrode active material layer.

In the first modification example described above, the temperature sensing unit is contained in the groove that is provided in the positive electrode active material layer, but is not limited thereto. For example, the temperature sensing unit may be contained in the groove that is provided in the negative electrode active material layer. In addition, in a case where the temperature sensing unit is contained in the groove that is provided in the positive electrode active material layer, the groove may not be provided in the negative electrode active material layer. In this case, it is possible to sufficiently ensure the capacity of the negative electrode. In addition, in the first modification example described above, the groove is provided in the positive electrode active material layers of all the power storage cells included in the cell stack, but is not limited thereto. For example, the groove may be provided only in the positive electrode active material layer of the power storage cell in which the temperature sensing unit is included, among the power storage cells included in the cell stack. In this case, the groove may be provided only in the negative electrode active material layer of the power storage cell in which the temperature sensing unit is included, among the power storage cells included in the cell stack, and the groove may not be provided in the negative electrode active material layers of all the power storage cells. It is possible to successfully suppress a reduction in the capacity of the power storage device due to the provision of the temperature sensing unit.

In the second modification example described above, the temperature sensing unit is contained in the concave portion that is provided in the positive electrode active material layer, but is not limited thereto. For example, the temperature sensing unit may be contained in a concave portion that is provided in the negative electrode active material layer. In addition, in one part of the power storage cells included in the cell stack, the temperature sensing unit may be contained in the concave portion that is provided in the positive electrode active material layer, and in the other part of the power storage cells, another temperature sensing unit may be contained in the concave portion that is provided in the negative electrode active material layer.

In the fourth modification example described above, the recess in which the temperature sensor is contained is provided in the second current collector included in one power storage cell, but is not limited thereto. For example, the recess may be provided in the first current collector included in the other power storage cell. In other words, in the stacking direction, a portion of the first current collector included in the other power storage cell, which overlaps with the temperature sensor, may be recessed toward the positive electrode active material layer in the other power storage cell. Alternatively, the recess may be provided in both of the second current collector and the first current collector. That is, when the temperature sensor is provided between two adjacent power storage cells, the recess in which the temperature sensor is contained may be provided in at least one of the first current collector of one power storage cell and the second current collector of the other power storage cell.

### REFERENCE SIGNS LIST

1, 1A to 1G: power storage device, 2, 2A to 21: power storage cell, 5, 5A, 5B: cell stack, 11: positive electrode, 12: negative electrode, 13: separator, 13a: base material layer, 13aa: first surface, 13ab: second surface, 13b: first adhesive layer, 13c: second adhesive layer, 13e, 20e, 21e: edge portion, 14: sealing portion, 14a: sealing body, 15: metal layer, 20: first current collector, 20a, 21a: one surface, 20b, 21b: the other surface, 21: second current collector, 22, 22A to 22C: positive electrode active material layer, 22a: groove, 22d: concave portion, 23, 23A, 23B: negative electrode active material layer, 23a: groove, 25: resin frame, 30: restraint member, 64, 64A: positive terminal electrode, 65, 65A: negative terminal electrode, 71, 71A: current collector, 100, 100A, 100B: temperature sensing unit, 101: temperature sensor, 102, 102A: lead wire, 102a: conductive foil (conductive portion), 102b: base film (insulating portion), 103: constantan wire, 111, 112: voltage measurement terminal (voltage detection unit), 200: sealing body, CM: cooling member, CP: conductive plate, S, S1: space, U1: positive electrode unit, U2: negative electrode unit.

1. An power storage device, comprising:
power storage cells stacked in a stacking direction; and
a temperature sensor configured to measure a temperature of at least one power storage cell to be measured among the power storage cells,
wherein each of the power storage cells includes:
a positive electrode including a first current collector, and a positive electrode active material layer provided on one surface of the first current collector;
a negative electrode including a second current collector, and a negative electrode active material layer provided on one surface of the second current collector, the negative electrode being arranged such that the negative electrode active material layer faces the positive electrode active material layer in the stacking direction;
a separator arranged between the positive electrode and the negative electrode; and
a sealing portion provided between the first current collector and the second current collector facing each other in the stacking direction, the sealing portion surrounding and sealing the positive electrode active material layer and the negative electrode active material layer, and
the temperature sensor is arranged inside from the sealing portion of the power storage cell to be measured when seen from the stacking direction.

2. The power storage device according to claim 1,
wherein the temperature sensor is in contact with the first current collector or the second current collector.

3. The power storage device according to claim 1, further comprising:
a stacked body including the power storage cells; and
a sealing body provided by integrating the sealing portions included in the power storage cells, respectively, the sealing body extending from one end to the other end of the stacked body in the stacking direction and sealing the stacked body,
wherein the temperature sensor is arranged between one end and the other end of the stacked body in the stacking direction.

4. The power storage device according to claim 1,
wherein the power storage cells include a first power storage cell and a second power storage cell adjacent to each other in the stacking direction,
the first current collector of the first power storage cell and the second current collector of the second power storage cell are adjacent to each other in the stacking direction, and
the temperature sensor is arranged between the first current collector of the first power storage cell and the second current collector of the second power storage cell.

5. The power storage device according to claim 1, further comprising:
a first stacked body including two or more power storage cells included in the power storage cells;
a second stacked body adjacent to the first stacked body in the stacking direction, the second stacked body including two or more other power storage cells included in the power storage cells;
a first sealing body provided by integrating the sealing portions of the power storage cells included in the first stacked body, the first sealing body extending from one end to the other end of the first stacked body in the stacking direction and sealing the first stacked body; and
a second sealing body provided by integrating the sealing portions of the power storage cells included in the second stacked body, the second sealing body extending from one end to the other end of the second stacked body in the stacking direction and sealing the second stacked body,
wherein the first current collector of a first power storage cell that is one power storage cell included in the first stacked body and the second current collector of a second power storage cell that is one power storage cell included in the second stacked body are adjacent to each other in the stacking direction, and
the temperature sensor is arranged between the first current collector that is a positive terminal electrode arranged on the one end of the first stacked body and the second current collector that is a negative terminal electrode arranged on the one end of the second stacked body.

6. The power storage device according to claim 5, further comprising:
a first cooler in contact with the positive terminal electrode of the first stacked body; and
a second cooler in contact with the negative terminal electrode of the second stacked body.

7. The power storage device according to claim 4,
wherein a recess in which the temperature sensor is contained is provided in at least one of the first current collector of the first power storage cell and the second current collector of the second power storage cell.

8. The power storage device according to claim 1,
wherein the power storage cells include a first power storage cell in which the temperature sensor is arranged, and
the temperature sensor is arranged in a space sealed by the sealing portion of the first power storage cell, the first current collector of the first power storage cell, and the second current collector of the first power storage cell.

9. The power storage device according to claim 8,
wherein the temperature sensor is contained in a groove provided in the positive electrode active material layer or a groove provided in the negative electrode active material layer.

10. The power storage device according to claim 8,
wherein the temperature sensor is embedded in the positive electrode active material layer or the negative electrode active material layer.

11. The power storage device according to claim 1,
wherein the temperature sensor is arranged in a center region of the power storage cell to be measured when seen from the stacking direction.

12. The power storage device according to claim 1, further comprising a plurality of temperature sensors including the temperature sensor,
wherein the plurality of temperature sensors are provided in the power storage cell to be measured, and
the plurality of temperature sensors arranged to be separated from each other when seen from the stacking direction are configured to measure a temperature distribution of the power storage cell to be measured.

13. The power storage device according to claim 1, further comprising
a flexible printed circuit electrically connected to the temperature sensor,
wherein the temperature sensor is provided on one end of the flexible printed circuit, and
the other end of the flexible printed circuit is connected to a control circuit arranged outside the power storage cells.

14. The power storage device according to claim 13,
wherein the flexible printed circuit includes a voltage detection unit in contact with a current collector included in any one of the power storage cells.

15. The power storage device according to claim 13,
wherein the flexible printed circuit includes a conductive portion connected to the temperature sensor, and an insulating portion covering the conductive portion, and
the temperature sensor is covered with the insulating portion.
